(19) United States
(12) Patent Application Publication
(10) Pub. No.: US 2026/0359577 A1
(43) Pub. Date: Nov. 12, 2026

(54) GENERATING DETECTION RULES FROM NATURAL LANGUAGE INPUT

(71) Applicant: International Business Machines Corporation, Armonk, NY (US)

(72) Inventors: Teryl Paul TAYLOR, Colorado Springs, CO (US); Shriti PRIYA, White Plains, NY (US); Frederico ARAUJO, Mahopac, NY (US); Ian Michael MOLLOY, Westchester, NY (US)

(21) Appl. No.: 19/201,372

(22) Filed: May 7, 2025

(51) Int. Cl. G06F 40/40

(52) U.S. Cl. CPC G06F 40/40

(57) ABSTRACT

In some implementations, a device may receive a natural language prompt. The device may convert the natural language prompt into an intermediate representation comprising a subject, an object, and an action. The device may disambiguate the subject, the object, and the action in the intermediate representation to form a disambiguated intermediate representation. The device may enrich the disambiguated intermediate representation with relevant information to form an enriched intermediate representation. The device may convert the enriched intermediate representation into a detection rule.

### BACKGROUND

This disclosure relates to natural language prompts, and more specifically, to security using the prompts.

### SUMMARY

Some aspects described herein relate to a method. The method may include receiving a natural language prompt. The method may include converting the natural language prompt into an intermediate representation comprising a subject, an object, and an action. The method may include disambiguating the subject, the object, and the action in the intermediate representation to form a disambiguated intermediate representation. The method may include enriching the disambiguated intermediate representation with relevant information to form an enriched intermediate representation. The method may include converting the enriched intermediate representation into a detection rule.

Some aspects described herein relate to a computer system. The computer system may include a processor set, one or more computer-readable storage media, and program instructions stored on the one or more computer-readable storage media to cause the processor set to perform operations. The operations may include receiving a natural language query. The operations may include lifting the natural language query into a structured intermediate representation by: converting the natural language query into a tuple of a subject, an object, and an action, constraining the tuple using types and attributes, expanding the intermediate representation to generate a disambiguated query, where the expanding comprises performing one or more of validation, attribute enrichment, or user follow-up, and synthesizing a detection rule from the disambiguated query.

Some aspects described herein relate to a computer program product. The computer program product may include one or more computer-readable storage media and program instructions stored on the one or more computer-readable storage media to perform operations. The operations may include expanding the intermediate representation to disambiguate and complete information in the intermediate representation, the expanding being performed by a combination of large language models (LLMs) and retrieval augmented generation. The operations may include synthesizing a query from the expanded intermediate representation, the query being in a query language and the synthesizing being performed by a combination of the LLMs and a rule of thumb analysis. The operations may include validating the query to ensure that the query is valid and accurate, the validating being performed by a set of validation metrics.

### BRIEF DESCRIPTION OF THE DRAWINGS

FIG. 1 is a diagram of an example computing environment for generating a detection rule from a natural language prompt.

FIGS. 2A-2B are diagrams showing an example of expanding and synthesizing a natural language query.

FIG. 3 is a diagram illustrating another example of generating a rule form a natural language prompt.

FIG. 4 illustrates a diagram of an example of generating a rule from a natural language prompt.

FIG. 5 is a flowchart of an example process associated with generating detection rules from natural language input.

FIG. 6 is a flowchart of an example process associated with generating detection rules from natural language input.

FIG. 7 is a flowchart of an example process associated with generating detection rules from natural language input.

### DETAILED DESCRIPTION

The following detailed description of example implementations refers to the accompanying drawings. The same reference numbers in different drawings may identify the same or similar elements.

Extended detection and response (XDR) is a comprehensive cybersecurity solution that integrates multiple security products into a unified platform, providing holistic threat detection and response capabilities across an organization's entire internet technology (IT) environment. XDR extends beyond endpoints to include network, server, email, and cloud security, offering unified visibility, advanced threat detection, automated response, and improved incident response. By correlating data from various security sources, XDR delivers context-rich insights into security incidents, enabling more accurate and efficient threat investigation. This integration and coordination of security tools streamline incident response processes, reducing the time and effort required to address security incidents, ultimately enhancing threat detection and response across the entire IT environment.

Endpoint detection and response (EDR) is a security solution focused on monitoring, detecting, and responding to threats on individual endpoints, such as desktops, laptops, and servers. EDR provides detailed visibility into endpoint activities, leveraging behavioral analysis, machine learning, and threat intelligence to identify suspicious activities and potential threats. With tools for in-depth investigation, forensic analysis, and threat hunting, EDR enables rapid detection and response to endpoint-specific threats. Automated response actions, such as isolating compromised endpoints and removing malware, further enhance security. EDR's data collection and analysis capabilities allow security teams to identify patterns, detect anomalies, and understand the root cause of incidents, improving visibility into endpoint activities and threats, and facilitating faster detection and remediation of security incidents.

A detection rule is a predefined set of criteria used to identify and alert on specific suspicious or malicious activities within an IT environment. A user may provide instructions to turn a security scenario into an actionable detection rule. This approach enhances the flexibility and efficiency of creating and managing security rules, allowing security teams to quickly adapt to emerging threats and complex attack patterns by simply describing them in natural language.

Converting natural language prompts into detection rules for XDR or EDR systems poses significant technical challenges. Existing methods rely heavily on manual creation of rule sets, which can be time-consuming and prone to human error. The inherent ambiguity of natural language, including lexical and syntactic ambiguities, context dependencies, and user mistakes, can lead to incorrect or incomplete rule generation. For example, the query may be, “Find processes that changed hosts file fewer than 10 times.” However, there is an inherent ambiguity. “What kind of processes? What does few mean here? Is there a given timeframe?” Furthermore, the user prompts may lack security knowledge that is essential to accurately detect threats. “What does hosts file mean? Which operating system is it for?” There may be a need for user clarification. “What does change mean here? Is it write or delete?”

Some implementations described herein provide a method for converting natural language prompts into detection rules for XDR or EDR systems. For example, a computer system may receive a natural language prompt, convert the natural language prompt into an intermediate representation (IR) comprising a subject (performing an action), an object (being acted upon), and the action based on information or knowledge stored for the computer system. For example, a natural language prompt such as “Find process that changed hosts file often,” the subject is “process,” the object is a “file,” and the action is “changed.” These are the computer system’s level entities that could be extracted from the natural language prompt and converted into an intermediate representation. The intermediate representation is a structured format that represents the sentence or statement before it is fully processed or converted into its final form. The computer system may then clarify or resolve ambiguities of the subject, the object, and the action of the intermediate representation. The computer system may disambiguate the subject, the object, and the action in the intermediate representation to form a disambiguated intermediate representation. The disambiguation may include knowledge enrichment for the different entities (subject, object and action) in the intermediate representation by adding relevant information including adding contextual information, threat intelligence, the computer system’s knowledge, user clarification, metadata attributes, properties, or external data sources or references to finally output a disambiguated prompt.

The computer system may then convert the enriched intermediate representation into a detection rule. This may include identifying the conditions or patterns that are to be detected. There may be key attributes that are associated with a behavior or event to be detected. The computer system may develop logical conditions for the detection rule and then map the attributes and values from the enriched intermediate representation to the conditions. The computer system may translate the rule logic into a format for execution, such as a scripting language, a rule-based engine, a query language, or a specialized tool.

In this way, the computer system may optimize computational resources by reducing the number of processing steps required for rule generation, resulting in improved computational efficiency and decreased latency. The compute system may also minimize memory utilization by identifying and eliminating redundant or unnecessary information in the intermediate representation. As a result, the method may conserve processing resources, memory resources, and/or the like.

In some implementations, the computer system may apply validation metrics to the intermediate representation to identify any structural, relational, or attribute level inconsistencies or ambiguities and apply the validation metrics to guide the disambiguation process. The computer system may also retrieve relevant information from a knowledge base and integrate the retrieved information into the disambiguated intermediate representation.

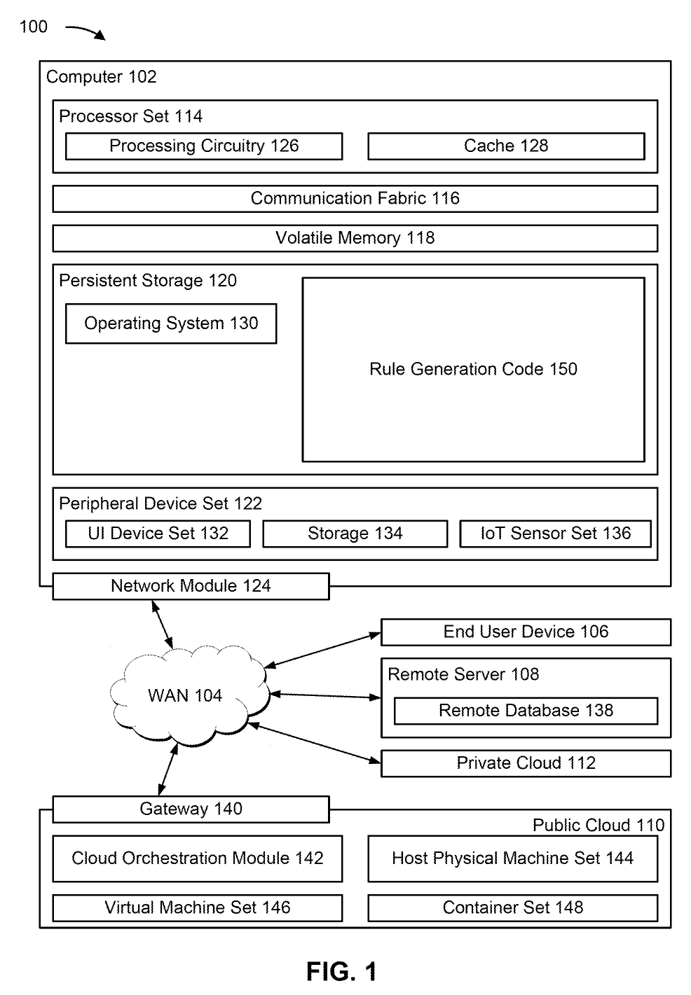

FIG. 1 is a diagram of an example computing environment 100 for generating a detection rule from a natural language prompt.

The computing environment 100 contains an example of an environment for the execution of at least some of the computer code involved in performing the inventive methods, such as rule generation code 150. In addition to the rule generation code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the rule generation code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in rule generation code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the rule generation code 150 typically includes at least some of the computer code involved in performing one or more operations described herein. The operations may include, for example, receiving a natural language prompt, converting the natural language prompt into an intermediate representation comprising a subject, an object, and an action, disambiguating the subject, the object, and the action in the intermediate representation to form a disambiguated intermediate representation, enriching the disambiguated intermediate representation with relevant information to form an enriched intermediate representation, and converting the enriched intermediate representation into a detection rule.

In some implementations, the operations may include receiving a natural language query and lifting the natural language query into a structured intermediate representation by converting the natural language query into a tuple of a subject, an object, and an action, constraining the tuple using types and attributes, expanding the intermediate representation to generate a disambiguated query, where the expanding comprises performing one or more of validation, attribute enrichment, or user follow-up, and synthesizing a detection rule from the disambiguated query.

In some implementations, the operations may include expanding the intermediate representation to disambiguate and complete information in the intermediate representation, the expanding being performed by a combination of large language models (LLMs) and retrieval augmented generation, synthesizing a query from the expanded intermediate representation, the query being in a query language and the synthesizing being performed by a combination of the LLMs and a rule of thumb analysis, and validating the query to ensure that the query is valid and accurate, the validating being performed by a set of validation metrics.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

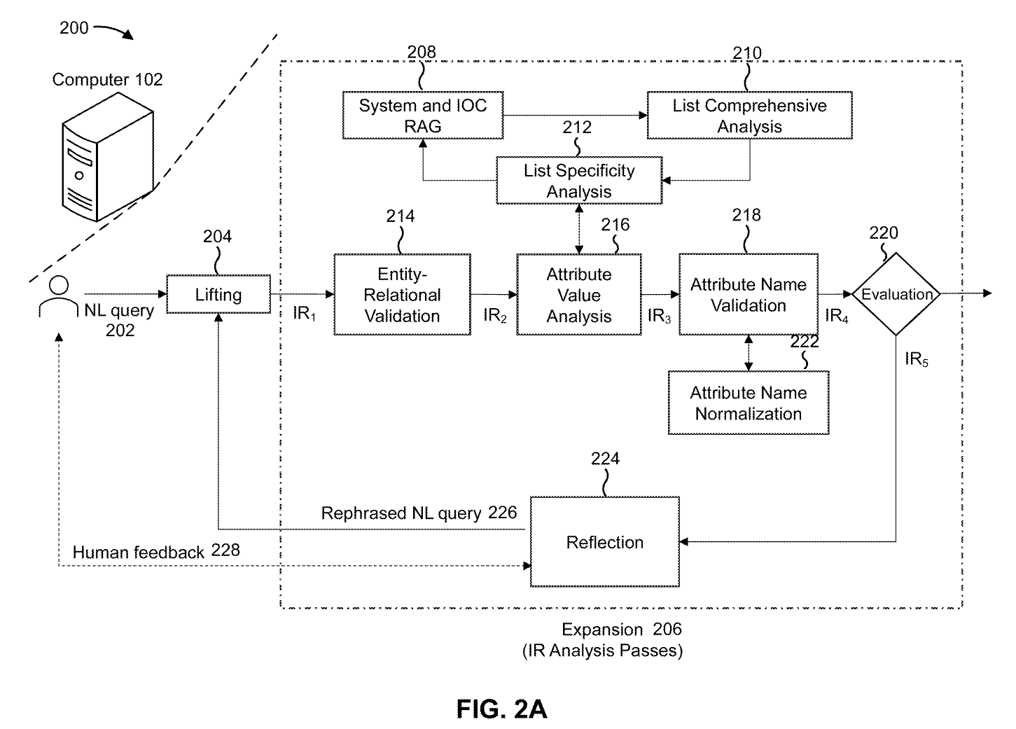

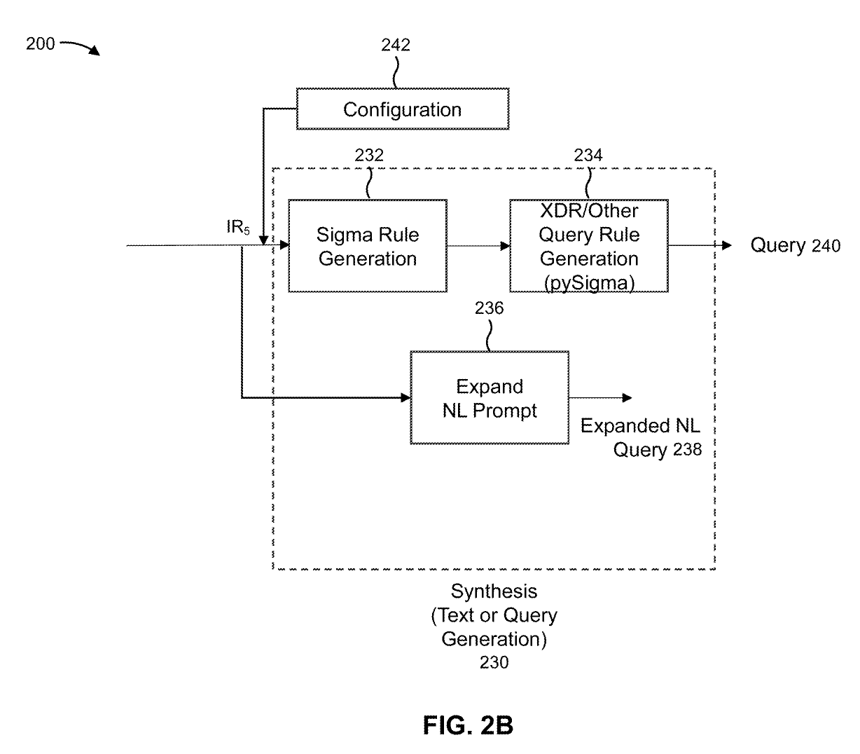

FIGS. 2A-2B are diagrams showing an example 200 of expanding and synthesizing a natural language query. For example, a computer system (e.g., computer 102) may receive a natural language (NL) query 202 and perform lifting 204 on the NL query. Lifting may include using an LLM to transform the NL query into a structured query (e.g., using a semantic query language (SQL), SPARQL, or a specific search engine query syntax) that could be an intermediate representation of the query. Lifting may involve parsing, which includes analyzing the grammatical structure of the NL query to understand the relationships between words and phrases. Lifting may also involve entity recognition, such as identifying and classifying key entities mentioned in the query, such as names, dates, and technical terms. Lifting may further involve intent detection, which includes determining the user's intent behind the query, such as whether they are looking for information, asking a question, or requesting a specific action. Lifting enables an iterative process for expansion or disambiguation, limits hallucinations, and converts a user prompt into a subject, object and action paradigm.

For example, if the NL query “Find process that changed hosts file often,” the lifting process would involve parsing the sentence to understand its structure, recognizing “process,” “file,” and “changed” as key entities, detecting the intent to retrieve information about the process, and formulating a structured query.

The lifted query may proceed to expansion 206 as a bounded intermediate representation (IR), or IR₁. Constraining the NL query to subject-object-action paradigm makes it a bounded problem to solve. The expansion of the IR₁ may refine and optimize the IR₁ to ensure accurate and comprehensive retrieval of relevant information. The expansion may add synonyms or related terms to the IR₁ to capture variations in terminology, resulting in IR₂. The action may include a write.

As part of the expansion, the query may undergo entity-relational validation 214. Entity-related validation is a process used to ensure that the entities identified in a query or document are accurate, relevant, and correctly classified. For example, the computer system validates the IR₁ if the generated IR contains entities like a subject, an object, and an action. Here, in an example like “Find process that changed hosts file,” the entity relational validation may be a process to check if the subject (process) is performing actions that are limited to read or write or are performing action such as create or delete on the object (file), because at the computer system’s level these are the only operations that could be performed by a process on a file. This would be similar for other entities like network, device, etc.

The IR₂ then proceeds to attribute value analysis 216. Attribute value analysis is a process used to examine and evaluate the specific values associated with attributes or properties of entities within a dataset or document. The computer system extracts a value using RAG and assures the extracted information is comprehensive. The goal of attribute-value analysis 216 is to convert a general ambiguous term into something more specific. For example, the NL query at IR₃ may be expanded to “Find process that wrote to file C:\Windows\System32\drivers\etc\hosts or file/etc/hosts. The word “host file” may be converted to “/etc/hosts” on a particular machine. In another example, the words “Anubis malware IOCs” may be broken out to the specific IP addresses, domain names, and process names that are associated with that virus. The list comprehensive analysis 210 makes sure the list is complete.

The IR₃ proceeds to attribute name validation 218. The computer system validates the IR₃ if the attribute name belongs to a predefined list. If not, the computer system normalizes attributes to elements of the list. Attribute name normalization 222 involves standardizing the naming conventions of attributes across a dataset based on a predefined list to ensure consistency and uniformity, which facilitates easier data integration, comparison, and analysis. For example the attribute name may result in the <file.name = hosts file>. The LLM, when performing the lifting, may cause the attribute while lifting to be file.id, but the attribute name normalization changes that to file.name. This is to ensure a uniform set of attributes are used in the synthesis stage for rule of thumb analysis.

The system and the indications of compromise (IOC) RAG 208 is a framework used to monitor and manage the performance and status of a system's input and output operations, providing a comprehensive approach to data handling. The RAG framework focuses on retrieving relevant data, augmenting the IR with additional context or information, and generating meaningful outputs to ensure efficient and effective system performance. List specificity analysis 212 involves evaluating the precision and detail of items within a list to ensure they are accurately and comprehensively described, enhancing the clarity and usefulness of the information presented. List comprehensive analysis 210 involves assessing the completeness and thoroughness of items within the list to ensure that all relevant and necessary elements are included, providing a holistic view of the subject matter.

That is, the attribute name validation 218 validates and normalizes the attribute names in the intermediate representation. For example, if process X is reading file Y, the attribute name validation 218 may ensure that the attributes are process.name, and file.name in the query. LLMs can hallucinate and make up attribute names so this is a check that the name matches a list of predefined attributes that were created.

The computer system may evaluate the IR₄, at 220, to determine if the IR₄ is to proceed to synthesis (e.g., passes validation) as disambiguated IR₅. If not, reflection 224 may result in a rephrased NL query 226 that is returned to the lifting 204. Human feedback 228 may also be provided to the user.

The evaluation 220 may result in passing the IR₅ for synthesis 230, shown by FIG. 2B. Synthesis involves converting an IR into either a text format or creating a detection rule. For example, the synthesis may convert the disambiguated IR₅ into a disambiguated NL format or creating a detection rule out of the disambiguated IR₅.

In some implementations, the synthesis may involve Sigma rule generation 232, XDR/query rule generation 234 (e.g., using pySigma), or expansion of the NL prompt 236, which results in an expanded NL query 238 or another resultant query 240. Sigma rule generation 232 is a technique used to create platform-agnostic rules for identifying potential security threats in threat detection and security information and event management (SIEM) systems. The process involves defining patterns and conditions to match specific threats, creating a Sigma rule, and testing and refining it to ensure effective threat detection. Sigma rule generation 232 focuses on creating standardized detection rules, while XDR/query rule generation 234 leverages tools like pySigma to formulate complex queries across extended detection and response systems. Expanding the NL prompt 236 enhances the initial query by adding context or additional terms, thereby refining the search criteria. The computer system may utilize a specific configuration 242 for the synthesis process, ensuring that the rules and queries are generated and expanded according to predefined parameters and standards, ultimately leading to more accurate and comprehensive information retrieval.

In some implementations, once the validation step is completed, the computer system has a disambiguated or complete IR for the provided NL query. The computer system may use XDR rule-of-thumb analysis that utilizes the domain of how a rule is typically written in the language or utilizes XDR rule generation that is based on the domain knowledge to write a detection rule.

An example of an extensible markup language (XML) query may be filter event_type = ENUM.FILE and event_sub_type = ENUM.FILE_WRITE and lowercase(action_file_path) in ("/etc/hosts", "c:\windows\system32\drivers\etc\hosts") | fields actor_process_image_path as Process_Path, actor_process_command_line as Command_Line, action_file_path as File_Path,event_id | comp count(event_id) as Counter by Process_Path, Command_Line, File_Path | filter Counter < 10.

An example of a Sigma query may be title: Process Modified Windows Hosts File

id: xxxx, status: experimental, description: Detects any process that modifies the Windows hosts file, author: Your Name, date: 2025/XX/XX, references: - https://superuser.com/questions/1303636/hosts-file-is-updated-by-some-process, logsource: category: file_event, detection: selection: TargetFilename|endswith: '\Windows\System32\drivers\etc\hosts', condition: selection, falsepositives: - Legitimate administrative changes, level: medium.

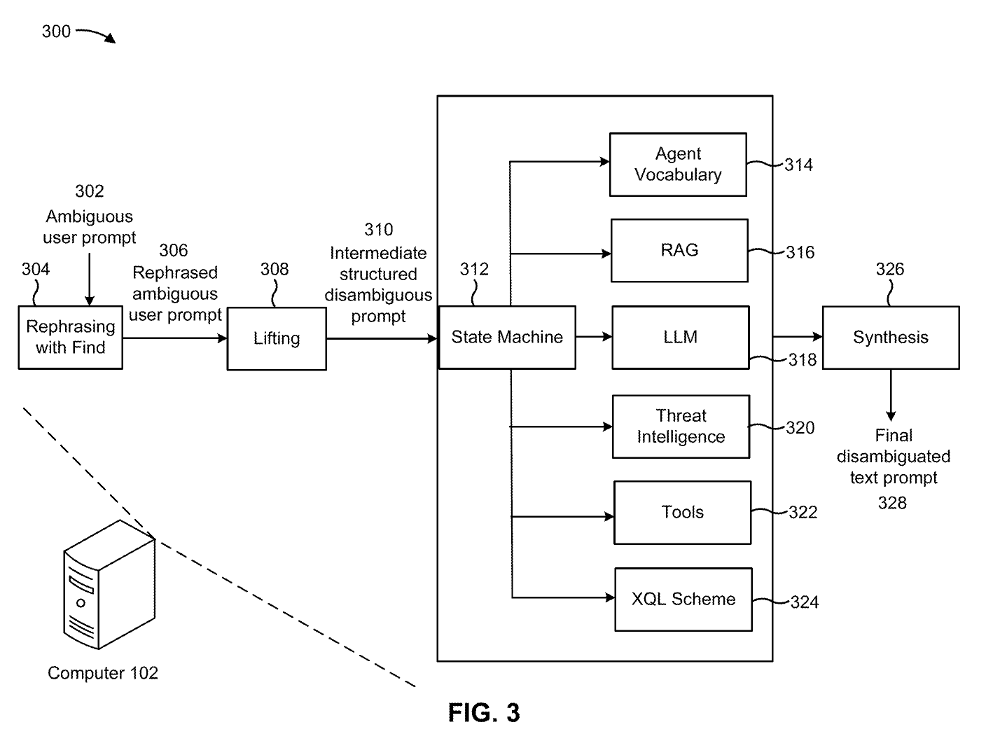

FIG. 3 is a diagram illustrating another example 300 of generating a rule from an NL prompt. The computer system may create an IR for representing the system’s behavior that can be targeted to multiple query languages. Example 300 shows a solution for disambiguating NL prompts by identifying and iterating over missing information using IR representation. An LLM may have the capability to identify the missing information and disambiguate the IR with the relevant information using RAG, threat intelligence, and so forth. The computer system may perform prompt tuning for disambiguating different system entities like process, file or network. The computer system may use the LLM and RAG for user clarification. The IR may be constrained by the LLM for validation, and the computer system may curate set of validation scores for IR. The computer system may offer prompt rewriting and a user loop, based on the validation scores.

Example 300 shows a state machine 312, iterated over multiple attributes to determine which parts lack information or are ambiguous. Each attribute is iterated within the structure and the IR is disambiguated using a knowledge base such as RAG 316, custom tools 322, LLMs 318, threat intelligence sources 320, a predefined agent vocabulary 314, and an XDR query language (XQL) scheme 324. An XQL scheme is a framework that defines the syntax and semantics of queries used to retrieve and analyze security-related data in XDR systems.

Ambiguous user input 302 (e.g., query) may be received by the computer system at 304, where the query is rephrased with find. Rephrasing with “find” may means altering the wording of a sentence or query to include the verb “find,” which emphasizes the action of searching for or locating specific information or items. This can make the request or instruction clearer and more direct in the context of information retrieval or search tasks. The resulting IR is a rephrased ambiguous user prompt 306 that proceeds to lifting 308. The lifting 308 results in an intermediate structured disambiguous prompt 310 that proceeds to the state machine 312. After the state machine 312 outputs the IR to the synthesis 326, the final output is a final disambiguated text prompt 328.

In some implementations, the computer system may lift the rephrased ambiguous user prompt 306 by converting the prompt into a tuple of a subject, an object, and an action. A tuple may be a structured format for elements. In this example, the structured format is for the subject, the object, and the action. The lifting 308 may also include constraining the tuple using types and attributes. This may include further refining the tuple by assigning specific types and attributes to each element to ensure clarity and precision. For example, defining the subject as a "process," the object as a "file," and the action as "modifying." The computer system may expand the IR to generate a disambiguated query (e.g., performing validation, attribute enrichment, or user follow-up) and synthesize a detection rule from the disambiguated query. As a result, the computer system may generate a more accurate detection rule that provides better security and that does not waste processing resources.

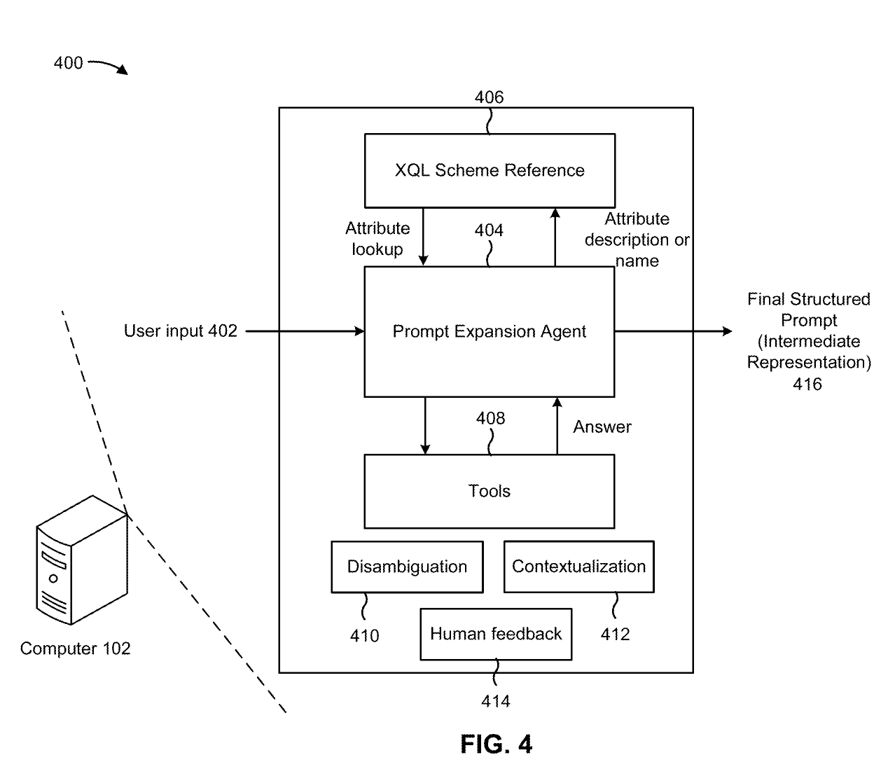

FIG. 4 illustrates a diagram of an example 400 of generating a rule from a natural language prompt.

Example 400 shows that the computer system may receive user input 402, such as a NL prompt, and use a prompt expansion agent 404, such as shown by expansion 206 in FIG. 2A, to output a final structured prompt or IR 416. The computer system may use an XQL scheme reference 406 for attribute lookup and for attribute descriptions and names. The computer system may also utilize tools 408 for disambiguation 410 of the user input 402 and IRs. This may involve applying validation metrics to identify any inconsistencies or ambiguities and guiding the disambiguating process using the validation metrics.

Additionally, or alternatively, the computer system may evaluate the disambiguated query using a validation score that includes metrics for attribute matching and feasibility. For example, the computer system may assess the accuracy of the disambiguated query by evaluating the degree of matching between the query and the attributes of the relevant data.

The computer system may enrich the disambiguated IR with relevant information to form an enriched IR. The computer system may use tools for contextualization 412 to infuse security information or add other contextual information to a disambiguated IR and to provide human feedback 414 for improved user inputs. In some implementations, the computer system may use custom tools or threat intelligence sources for expanding the IR. For example, the computer system may use custom-built tools to retrieve relevant information from proprietary databases or integrate threat intelligence feeds to enrich the intermediate representation.

The computer system may add synonyms or related terms to the intermediate representation to capture variations in terminology. This may also include adding broader related concepts to the query and adding contextually relevant terms based on the user's previous queries or known preferences. The computer system may retrieve relevant information from a knowledge base and integrating the knowledge into the disambiguated IR.

The computer system may convert the enriched IR into a detection rule. This may include identifying the conditions or patterns that are to be detected and customizing the detection rule based on user-defined settings. In some implementations, the computer system may use a combination of natural language processing (NLP) and machine learning techniques for converting into the IR. For example, the computer system may use NLP techniques such as named entity recognition, part-of-speech tagging, or dependency parsing to identify key elements of the NL prompt and then apply machine learning algorithms to generate the intermediate representation.

The computer system may provide explanations for the detection rule. This may involve generating text that explains the reasoning behind the detection rule and the input used to generate the detection rule. The computer system may be integrated with a user interface to allow users to input NL prompts and receive generated detection rules and the associated explanations.

In some aspects, the disambiguating and enriching process may be performed iteratively until a specified level of accuracy is achieved. For example, the computer system may iteratively refine the disambiguated IR by reapplying validation metrics and retrieving additional relevant information until the desired level of accuracy is achieved.

Additionally, or alternatively, the computer system may handle incomplete or uncertain data with the converting to the IR. For example, the computer system may use LLMs and machine learning techniques to infer missing information or estimate uncertain data.

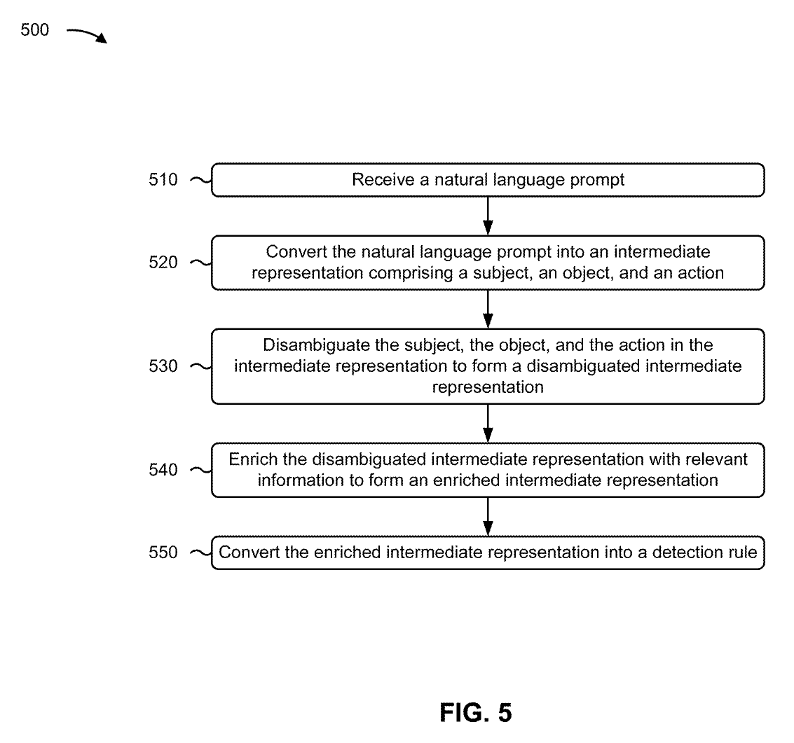

FIG. 5 is a flowchart of an example process 500 associated with generating detection rules from natural language input. One or more process blocks of FIG. 5 are performed by a computer system (e.g., computer 102) and/or by another device or a group of devices separate from or including the computer system.

As shown in FIG. 5, process 500 includes receiving a natural language prompt (block 510). For example, the computer system may receive a natural language prompt, as described above.

As further shown in FIG. 5, process 500 includes converting the natural language prompt into an intermediate representation comprising a subject, an object, and an action (block 520). For example, the computer system may convert the natural language prompt into an intermediate representation comprising a subject, an object, and an action, as described above.

As further shown in FIG. 5, process 500 includes disambiguating the subject, the object, and the action in the intermediate representation to form a disambiguated intermediate representation (block 530). For example, the computer system may disambiguate the subject, the object, and the action in the intermediate representation to form a disambiguated intermediate representation, as described above.

As further shown in FIG. 5, process 500 includes enriching the disambiguated intermediate representation with relevant information to form an enriched intermediate representation (block 540). For example, the computer system may enrich the disambiguated intermediate representation with relevant information to form an enriched intermediate representation, as described above.

As further shown in FIG. 5, process 500 includes converting the enriched intermediate representation into a detection rule (block 550). For example, the computer system may convert the enriched intermediate representation into a detection rule, as described above.

Process 500 may include additional aspects, such as any single aspect or any combination of aspects described below and/or in connection with one or more other processes described elsewhere herein.

In a first aspect, the disambiguating comprises applying validation metrics to the intermediate representation to identify any inconsistencies or ambiguities, and applying the validation metrics to guide the disambiguating.

In a second aspect, alone or in combination with the first aspect, the enriching comprises retrieving, using a knowledge base, relevant information related to the subject, the object, and the action, and integrating the retrieved information into the disambiguated intermediate representation.

In a third aspect, alone or in combination with one or more of the first and second aspects, the converting comprises converting, using a template-based approach, the enriched intermediate representation into a detection rule, and customizing the detection rule based on user-defined settings.

In a fourth aspect, alone or in combination with one or more of the first through third aspects, the disambiguating and the enriching are performed iteratively until a specified level of accuracy is achieved.

In a fifth aspect, alone or in combination with one or more of the first through fourth aspects, the converting into the intermediate representation comprises using a combination of NLP and machine learning techniques.

In a sixth aspect, alone or in combination with one or more of the first through fifth aspects, the NLP techniques comprise naming entity recognition, part-of-speech tagging, or dependency parsing.

In a seventh aspect, alone or in combination with one or more of the first through sixth aspects, the detection rule is in a format compatible with a SIEM system.

In an eighth aspect, alone or in combination with one or more of the first through seventh aspects, the converting the enriched intermediate representation into the detection rule is adaptable to different types of detection rules and security systems.

In a ninth aspect, alone or in combination with one or more of the first through eighth aspects, process 500 includes handling incomplete or uncertain data with the converting to the intermediate representation.

In a tenth aspect, alone or in combination with one or more of the first through ninth aspects, process 500 includes providing explanations for the generated detection rule.

In an eleventh aspect, alone or in combination with one or more of the first through tenth aspects, the converting of the natural language prompt is integrated with a user interface to allow users to input natural language prompts and receive generated detection rules.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

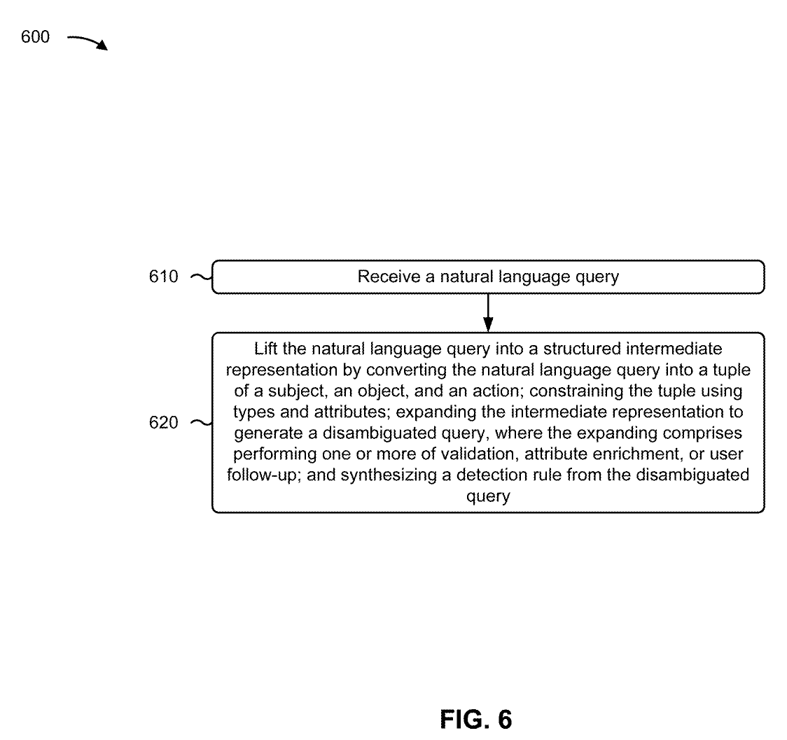

FIG. 6 is a flowchart of an example process 600 associated with generating detection rules from natural language input. One or more process blocks of FIG. 6 are performed by a computer system (e.g., computer 102) and/or by another device or a group of devices separate from or including the computer system.

As shown in FIG. 6, process 600 includes receiving a natural language query (block 610). For example, the computer system may receive a natural language query, as described above.

As further shown in FIG. 6, process 600 includes lifting the natural language query into a structured intermediate representation by: converting the natural language query into a tuple of a subject, an object, and an action; constraining the tuple using types and attributes; expanding the intermediate representation to generate a disambiguated query, where the expanding comprises performing one or more of validation, attribute enrichment, or user follow-up; and synthesizing a detection rule from the disambiguated query (block 620). For example, the computer system may lift the natural language query into a structured intermediate representation by: converting the natural language query into a tuple of a subject, an object, and an action; constraining the tuple using types and attributes; expanding the intermediate representation to generate a disambiguated query, where the expanding comprises performing one or more of validation, attribute enrichment, or user follow-up; and synthesizing a detection rule from the disambiguated query, as described above.

Process 600 may include additional aspects, such as any single aspect or any combination of aspects described below and/or in connection with one or more other processes described elsewhere herein.

In a first aspect, the detection rule is in an extended detection and response query language, a Kusto query language, or a Sigma detection language.

In a second aspect, alone or in combination with the first aspect, the operations further comprise evaluating the disambiguated query using a validation score that includes metrics for attribute matching and feasibility.

In a third aspect, alone or in combination with one or more of the first and second aspects, the expanding uses at least one of a LLM, RAG, custom tools, or threat intelligence sources.

In a fourth aspect, alone or in combination with one or more of the first through third aspects, the synthesizing comprises converting the disambiguated query into a rule format using a tool for converting sigma rules into queries.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

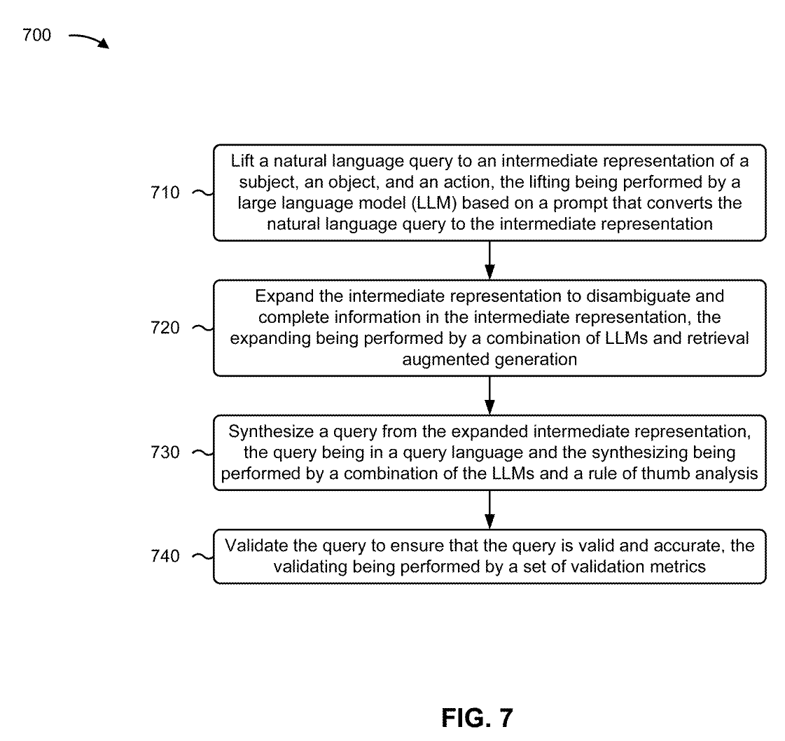

FIG. 7 is a flowchart of an example process 700 associated with generating detection rules from natural language input. One or more process blocks of FIG. 7 are performed by a computer system (e.g., computer 102) and/or by another device or a group of devices separate from or including the computer system.

As shown in FIG. 7, process 700 includes lifting a natural language query to an intermediate representation of a subject, an object, and an action, the lifting being performed by an LLM based on a prompt that converts the natural language query to the intermediate representation (block 710). For example, the computer system may lift a natural language query to an intermediate representation of a subject, an object, and an action, the lifting being performed by an LLM based on a prompt that converts the natural language query to the intermediate representation, as described above.

As further shown in FIG. 7, process 700 includes expanding the intermediate representation to disambiguate and complete information in the intermediate representation, the expanding being performed by a combination of LLMs and retrieval augmented generation (block 720). For example, the computer system may expand the intermediate representation to disambiguate and complete information in the intermediate representation, the expanding being performed by a combination of LLMs and retrieval augmented generation, as described above.

As further shown in FIG. 7, process 700 includes synthesizing a query from the expanded intermediate representation, the query being in a query language and the synthesizing being performed by a combination of the LLMs and a rule of thumb analysis (block 730). For example, the computer system may synthesize a query from the expanded intermediate representation, the query being in a query language and the synthesizing being performed by a combination of the LLMs and a rule of thumb analysis, as described above.

As further shown in FIG. 7, process 700 includes validating the query to ensure that the query is valid and accurate, the validating being performed by a set of validation metrics (block 740). For example, the computer system may validate the query to ensure that the query is valid and accurate, the validating being performed by a set of validation metrics, as described above.

Process 700 may include additional aspects, such as any single aspect or any combination of aspects described below and/or in connection with one or more other processes described elsewhere herein.

In a first aspect, the operations further comprise using the validation metrics to guide the LLMs to perform self-reflection or to ask for user clarification or prompt rewriting.

In a second aspect, alone or in combination with the first aspect, the operations further comprise converting the query from one query language to another query language using a conversion tool, the conversion tool being based on a Sigma rule.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a natural language prompt;
converting the natural language prompt into an intermediate representation comprising a subject, an object, and an action;
disambiguating the subject, the object, and the action in the intermediate representation to form a disambiguated intermediate representation;
enriching the disambiguated intermediate representation with relevant information to form an enriched intermediate representation; and
converting the enriched intermediate representation into a detection rule.

2. The method of claim 1, wherein the disambiguating comprises:
applying validation metrics to the intermediate representation to identify any inconsistencies or ambiguities; and
applying the validation metrics to guide the disambiguating.

3. The method of claim 1, wherein the enriching comprises:
retrieving, using a knowledge base, relevant information related to the subject, the object, and the action; and
integrating the retrieved information into the disambiguated intermediate representation.

4. The method of claim 1, wherein the converting comprises:
converting, using a template-based approach, the enriched intermediate representation into a detection rule; and
customizing the detection rule based on user-defined settings.

5. The method of claim 1, wherein the disambiguating and the enriching are performed iteratively until a specified level of accuracy is achieved.

6. The method of claim 1, wherein the converting into the intermediate representation comprises using a combination of natural language processing (NLP) and machine learning techniques.

7. The method of claim 6, wherein the NLP techniques comprise:
named entity recognition,
part-of-speech tagging, or
dependency parsing.

8. The method of claim 1, wherein the detection rule is in a format compatible with a security information and event management (SIEM) system.

9. The method of claim 1, wherein the converting the enriched intermediate representation into the detection rule is adaptable to different types of detection rules and security systems.

10. The method of claim 1, further comprising:
handling incomplete or uncertain data with the converting to the intermediate representation.

11. The method of claim 1, further comprising:
providing explanations for the detection rule.

12. The method of claim 1, wherein the converting of the natural language prompt is integrated with a user interface to allow users to input natural language prompts and receive generated detection rules.

13. A computer system comprising:
a processor set;
one or more computer-readable storage media; and
program instructions stored on the one or more computer-readable storage media to cause the processor set to perform operations comprising:
receiving a natural language query; and
lifting the natural language query into a structured intermediate representation by:
converting the natural language query into a tuple of a subject, an object, and an action;
constraining the tuple using types and attributes;
expanding the intermediate representation to generate a disambiguated query, wherein the expanding comprises performing one or more of validation, attribute enrichment, or user follow-up; and
synthesizing a detection rule from the disambiguated query.

14. The computer system of claim 13, wherein the detection rule is in an extended detection and response query language, a Kusto query language, or a Sigma detection language.

15. The computer system of claim 13, wherein the operations further comprise:
evaluating the disambiguated query using a validation score that includes metrics for attribute matching and feasibility.

16. The computer system of claim 13, wherein the expanding uses at least one of:
a large language model (LLM),
retrieval augmented generation (RAG),
custom tools, or
threat intelligence sources.

17. The computer system of claim 13, wherein the synthesizing comprises:
converting the disambiguated query into a rule format using a tool for converting sigma rules into queries.

18. A computer program product comprising:
one or more computer-readable storage media; and
program instructions stored on the one or more computer-readable storage media to perform operations comprising:
lifting a natural language query to an intermediate representation of a subject, an object, and an action, the lifting being performed by a large language model (LLM) based on a prompt that converts the natural language query to the intermediate representation;
expanding the intermediate representation to disambiguate and complete information in the intermediate representation, the expanding being performed by a combination of LLMs and retrieval augmented generation;
synthesizing a query from the expanded intermediate representation, the query being in a query language and the synthesizing being performed by a combination of the LLMs and a rule of thumb analysis; and
validating the query to ensure that the query is valid and accurate, the validating being performed by a set of validation metrics.

19. The computer program product of claim 18, wherein the operations further comprise:
using the validation metrics to guide the LLMs to perform self-reflection or to ask for user clarification or prompt rewriting.

20. The computer program product of claim 18, wherein the operations further comprise:
converting the query from one query language to another query language using a conversion tool, the conversion tool being based on a Sigma rule.
